(19) United States
(12) Patent Application Publication
(10) Pub. No.: US 2025/0245439 A1
(43) Pub. Date: Jul. 31, 2025

(54) SYSTEMS AND METHODS FOR DETECTING DATA DRIFT AND EXTRACTING DATA EXAMPLES AFFECTED BY DATA DRIFT

(71) Applicant: JPMORGAN CHASE BANK, N.A., New York, NY (US)

(72) Inventors: Myeongjun JANG, Oxford (GB); Antonios GEORGIADIS, London (GB); Fanny SILAVONG, London (GB)

(21) Appl. No.: 19/034,232

(22) Filed: Jan. 22, 2025

(30) Foreign Application Priority Data
Jan. 26, 2024 (GR) 20240100055

(51) Int. Cl. G06F 40/30; G06F 40/279

(52) U.S. Cl. CPC G06F 40/30; G06F 40/279

(57) ABSTRACT

A method may include: (1) receiving reference data comprising input texts and corresponding labels; (2) training a covariate drift detector comprising a syntactic drift detector and a semantic draft detector with the reference data; (3) training a concept drift detector comprising a plurality of classifiers with the reference data; (4) receiving production data comprising a plurality of instances; (5) determining that the production data has drifted; (6) calculating similarity scores between each instance of the production data and the reference data; (7) detecting concept drift by generating a predictive distribution using the plurality of classifiers and calculating an entropy of the predictive distribution; (8) identifying final drifted instances from the covariate drifted instances and the concept drifted instances; and (9) receiving updated labels for the final drifted instances.

### RELATED APPLICATIONS

This application claims priority to, and the benefit of, Greek Patent Application No. 20240100055, filed Jan. 26, 2024, the disclosure of which is hereby incorporated, by reference, in its entirety.

### BACKGROUND OF THE INVENTION

### 1. Field of the Disclosure

Embodiments relate generally to systems and methods for detecting data drift and extracting data examples affected by data drift.

### 2. Description of the Related Art

Recent advancements in machine learning (ML) and deep learning (DL) have propelled the emergence of diverse natural language processing (NLP) artificial intelligence (AI) solutions featuring cutting-edge ML and DL models. Nonetheless, their exclusive proficiency in inductive reasoning has given rise to substantial challenges when applied in practical business contexts. One such challenge is “data drift,” an inconsistency between reference (i.e., training) and production data distributions. As alterations in data distribution violate the fundamental assumption of ML, which posits an identical distribution between training and test data, the occurrence of data drift has the potential to aggravate the accuracy of previously trained models and ultimately damage the quality of AI services. Consequently, it is crucial to detect data drift and provide an updated model prior to customers experiencing the degradation in performance.

### SUMMARY OF THE INVENTION

Systems and methods for detecting data drift and extracting data examples affected by data drift are disclosed.

In some aspects, the techniques described herein relate to a method including: providing a covariate drift detector configuration; providing a concept drift detector configuration; inferring covariate drift instances using the covariate drift detector configuration; inferring concept drift instances using the concept drift detector configuration; and determining final drift instances based on the covariate drift instances and the concept drift instances.

In one embodiment, a method may include: (1) receiving by a computer program, reference data comprising input texts and corresponding labels; (2) training, by the computer program, a covariate drift detector comprising a syntactic drift detector and a semantic draft detector with the reference data; (3) training, by the computer program, a concept drift detector comprising a plurality of classifiers with the reference data; (4) receiving, by the computer program, production data comprising a plurality of instances; (5) determining, by the computer program, that the production data has drifted; (6) calculating, by the computer program, similarity scores between each instance of the production data and the reference data; (7) detecting, by the computer program, concept drift by generating a predictive distribution using the plurality of classifiers and calculating an entropy of the predictive distribution; (8) identifying, by the computer program, final drifted instances from the covariate drifted instances and the concept drifted instances; and (9) receiving, by the computer program, updated labels for the final drifted instances.

In one embodiment, the syntactic drift detector is trained by extracting content words from the reference data and calculating their frequencies.

In one embodiment, the semantic drift detector is trained by generating sentence vectors of the input texts in the reference data.

In one embodiment, the semantic drift detector comprises a variational autoencoder, and the variational autoencoder is trained with the generated sentence vectors.

In one embodiment, the syntactic covariate drift detector determines a likelihood of drift based on a frequency of content words.

In one embodiment, the method may also include: setting, by the computer program, a configuration for the covariate drift detector using a content word frequency and an output of the variational autoencoder.

In one embodiment, the instances comprise a sentence, a paragraph, or an entire document.

In one embodiment, the method may also include: calculating, by the computer program, a semantic covariate drift contribution score for each content word in the instances that are likely to have drifted; and calculating, by the computer program, a syntactic covariate drift contribution score for each content word in instances of the production data that are likely to have drifted using the syntactic drift detector and the semantic draft detector.

According to another embodiment, a system may include: a user electronic device executing a user computer program; and an electronic device executing a computer program. The computer program receives, from a database, reference data comprising input texts and corresponding labels; the computer program trains a covariate drift detector comprising a syntactic drift detector and a semantic draft detector with the reference data; the computer program trains a concept drift detector comprising a plurality of classifiers with the reference data; the computer program receives production data comprising a plurality of instances; the computer program determines that the production data has drifted; the computer program calculates similarity scores between each instance of the production data and the reference data; the computer program detects concept drift by generating a predictive distribution using the plurality of classifiers and calculating an entropy of the predictive distribution; the computer program identifies final drifted instances from the covariate drifted instances and the concept drifted instances; and the computer program receives, from the user computer program, updated labels for the final drifted instances.

In one embodiment, the syntactic drift detector is trained by extracting content words from the reference data and calculating their frequencies, and the semantic drift detector is trained by generating sentence vectors of the input texts in the reference data.

In one embodiment, the semantic drift detector comprises a variational autoencoder, and the variational autoencoder is trained with the generated sentence vectors.

In one embodiment, the syntactic covariate drift detector determines a likelihood of drift based on a frequency of content words.

In one embodiment, the computer program sets a configuration for the covariate drift detector using a content word frequency and an output of the variational autoencoder.

In one embodiment, the instances comprise a sentence, a paragraph, or an entire document.

In one embodiment, the computer program calculates a semantic covariate drift contribution score for each content word in the instances that are likely to have drifted, and a syntactic covariate drift contribution score for each content word in instances of the production data that are likely to have drifted using the syntactic drift detector and the semantic draft detector.

According to another embodiment, a non-transitory computer readable storage medium may include instructions stored thereon, which when read and executed by one or more computer processors, cause the one or more computer processors to perform steps comprising: receiving reference data comprising input texts and corresponding labels; training a covariate drift detector comprising a syntactic drift detector and a semantic draft detector with the reference data; training a concept drift detector comprising a plurality of classifiers with the reference data; receiving production data comprising a plurality of instances; determining that the production data has drifted; calculating similarity scores between each instance of the production data and the reference data; detecting concept drift by generating a predictive distribution using the plurality of classifiers and calculating an entropy of the predictive distribution; identifying final drifted instances from the covariate drifted instances and the concept drifted instances; and receiving updated labels for the final drifted instances.

In one embodiment, the syntactic drift detector is trained by extracting content words from the reference data and calculating their frequencies, and the semantic drift detector is trained by generating sentence vectors of the input texts in the reference data.

In one embodiment, the semantic drift detector comprises a variational autoencoder, and the variational autoencoder is trained with the generated sentence vectors.

In one embodiment, the non-transitory computer readable storage medium may also include instructions stored thereon, which when read and executed by the one or more computer processors, cause the one or more computer processors to perform steps comprising: setting a configuration for the covariate drift detector using a content word frequency and an output of the variational autoencoder.

In one embodiment, the non-transitory computer readable storage medium may also include instructions stored thereon, which when read and executed by the one or more computer processors, cause the one or more computer processors to perform steps comprising: calculating a semantic covariate drift contribution score for each content word in the instances that are likely to have drifted; and calculating a syntactic covariate drift contribution score for each content word in instances of the production data that are likely to have drifted using the syntactic drift detector and the semantic draft detector.

### BRIEF DESCRIPTION OF THE DRAWINGS

FIG. 1 depicts a system for detecting data drift and extracting data examples affected by data drift according to an embodiment.

FIG. 2 depicts a method for detecting data drift and extracting data examples affected by data drift according to an embodiment.

FIG. 3 depicts a block diagram of a technology infrastructure and computing device for implementing certain aspects of the present disclosure, in accordance with aspects.

### DETAILED DESCRIPTION OF PREFERRED EMBODIMENTS

Embodiments generally relate to systems and methods for detecting data drift and extracting data examples affected by data drift.

Data drift, which denotes a misalignment between the distribution of reference (i.e., training) and production data, constitutes a significant challenge for AI applications, as it undermines generalization capacity of machine learning (ML) models. Therefore, it is important to proactively identify data drift before users meet with performance degradation. Moreover, in order to ensure the successful execution of AI services, endeavors may be directed not only toward detecting the occurrence of drift but also toward effectively addressing this challenge.

Embodiments are generally directed to a tool that detects data drift in text data. In addition, embodiments are directed to an unsupervised sampling technique for extracting representative examples from drifted instances. An instance may be a sentence, a paragraph, an entire document, etc., and an instance type may be reference data or production data. This mitigates the temporal and financial expenses associated with annotating the labels for drifted instances, an essential prerequisite for retraining the model to sustain its performance on production data.

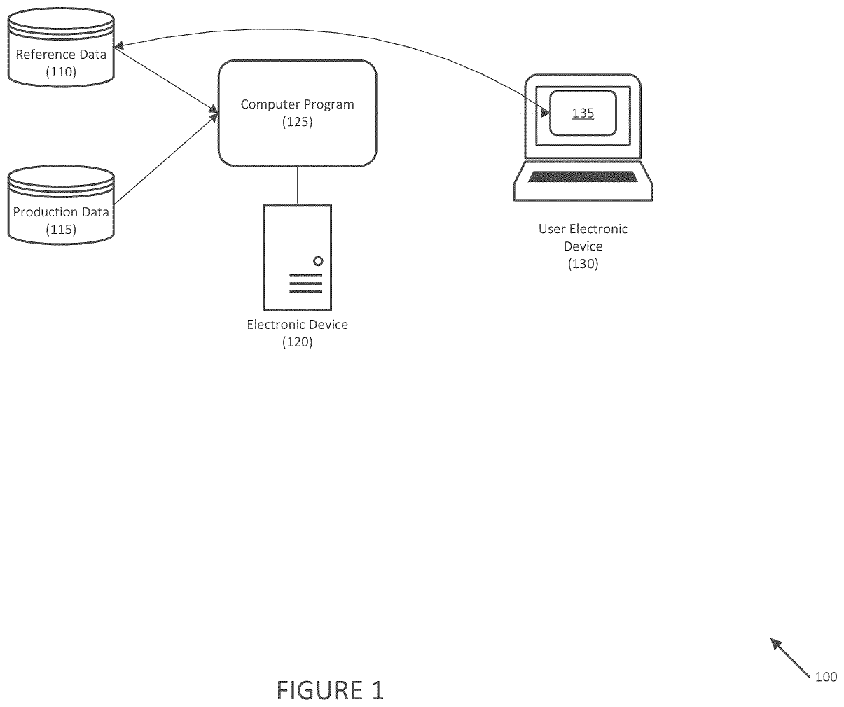

Referring to FIG. 1, a system for detecting data drift and extracting data examples affected by data drift is disclosed according to an embodiment. System 100 may include source of reference data 110, source of production data source 115, electronic device 120 that may execute computer program 125, and user electronic device 130 that may execute user computer program 135. Electronic device 120 and user electronic device 130 may include servers (e.g., physical and/or cloud-based), computers (e.g., workstations, desktops, laptops, notebooks, tablets, etc.).

Each instance of reference data in source of reference data 110 may include two variables, “input text” and “target class.” For example, if the task is sentiment analysis, an input text may be “This movie is quite good” and a target class can be “positive”. If the task is feedback classification from app reviews, an input text may be: “The software integration works great”, and a target class may be “software integration”. Embodiments may be generally applicable in any situation that includes a reference set (with input texts and target labels), and a production set (which would only need to be the texts) to identify whether they have drifted from the reference.

Each instance of production data in production data source 115 may only have the input text, and there is no need to have target class. An example of production data may be: “The new payments feature is crashing when I open it with face ID.”

Computer program 125 may detect data draft between the reference data and the production data, and may annotate predicted instances that were affected by data draft.

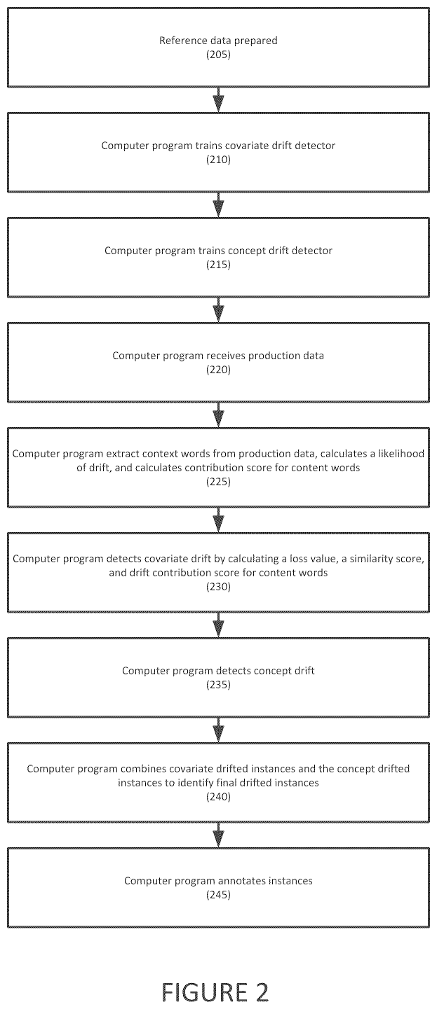

Referring to FIG. 2, a method for detecting data drift and extracting data examples affected by data drift is disclosed according to an embodiment.

In step 205, reference data may be prepared. For example, the reference data may include input texts and corresponding target labels.

In one embodiment, the reference data may be prepared by removing misclassifications, typographic errors, etc.

In step 210, a computer program may use the reference data to train a covariate drift detector that may include a syntactic drift detector and a semantic drift detector. The syntactic covariate drift detector may use a likelihood of drift using the frequency of content words, and the semantic covariate drift detector may use a variational autoencoder (VAE). VAEs are generative models used in machine learning to generate new data in the form of variations of the input data they are trained on.

For example, the computer program may train a syntactic drift detector by extracting content words from the reference data and calculating their frequencies, a semantic drift detector by generating sentence vectors of the input texts in the reference data, and may train the VAE with the generated sentence vectors.

The computer program may use a content word frequency and the output of the VAE to set a configuration for the covariate drift detector. For example, the configuration may include thresholds for detecting data drift, the boundary of normal drift-likelihood score for word frequency, and similarity score for the VAE.

In step 215, the computer program may train a concept drift detector. In one embodiment, the computer program may train a certain number of classifiers using the reference dataset. For example, five classifiers may be trained; other numbers of classifiers may be trained as is necessary and/or desired. The classifiers may be machine learning models that are designed to categorize unseen data into predefined classes. For example, reference data that consists of movie reviews may have predefined classes of positive and negative. When the classifier is trained on the reference data, it will predict the sentiment of unseen movie reviews from test or production data.

In step 220, the computer program may receive production data comprising a plurality of instances. The production data may include texts received during a production (e.g., deployment) stage.

In step 225, the computer program may extract content words (e.g., nouns, verbs, adjectives, adverbs) from the production data and calculate a likelihood of drift for each instance in the production data based on the pre-calculated frequency of extracted words from the reference data. The likelihood may be calculated as follows:

$${ℒ}_{x} = \frac{1}{\vert {x}_{c} \vert} {\sum }_{w ∈ {x}_{c}} log F ( w )$$

where x_{c} is a set of content words, and F(w) is a frequency of word w.

Instances of production text having a likelihood below a threshold may be considered to be drifted, while instances that are above or equal to the threshold are not considered to be drifted. In one embodiment, the threshold may be a value that is used to decide whether a production instance is drifted or not. If a likelihood of a production instance is below the threshold, it is considered to be drifted. The threshold is a hyperparameter where the value is defined by the user.

Next, for each content word in an instance that is below the threshold, the computer program may calculate a syntactic covariate drift contribution score (c_{w}) that denotes implies a content word's contribution toward syntactic covariate drift. The syntactic covariate drift contribution score may be calculated as follows:

$${c}_{w} = \frac{{\sum }_{k ∈ {x}_{c}}}{} \\ where : \\ = \frac{{ℒ}_{x}}{log F ( w )}$$

The syntactic covariate drift contribution score may be calculated for interpretability purposes. The content words with high contribution scores denote that those words are a leading cause of the syntactic covariate drift. Hence, out of this system, users may add more instances containing such words to data to avoid syntactic covariate drift.

Next, in step 230, the computer program may detect covariate, or semantic, drift using the semantic draft detector employing VAE. For example, for each instance in the production data, the computer program may calculate a loss value (loss), which is the output of the VAE.

Notably, the VAE's parameters were updated in the way to minimize the loss value during the training phase.

Next, the computer program may calculate similarity scores, s, between the production instance and the reference dataset using the loss values. For example, the similarity score may be calculated for each instance. The similarity score may be calculated as s=e^{-loss}. Instances where the similarity score is below a threshold, which may be determined by the user, are considered as drifted.

For each word in a drifted instance, the computer program may calculate a semantic covariate drift contribution score (cᵢ) that implies a word's contribution toward semantic covariate drift. The semantic covariate drift contribution score cᵢ may be calculated as follows:

$${D}_{i} = \frac{{s}_{i} - s}{σ} \\ where : \\ {c}_{i} = \frac{{e}^{{D}_{i}}}{{\sum }_{k = 1}^{n} {d}^{{D}_{k}}}$$

The semantic covariate drift contribution score may be used for interpretability purposes.

In step 235, the computer program may detect concept drift. For each instance in the production data, the computer program may generate a predictive distribution by using the pre-trained classifiers. The classifiers take a text as an input and generate a predictive distribution as an output. For example, if the model is trained with 4 pre-defined classes (e.g., C1, C2, C3, and C4), the output may become {“C1”: 0.1, “C2”: 0.2, “C3”: 0.2, “C4”: 0.5}, where each numeric value denotes the probability that the given input belongs to the corresponding class. As the probability of C4 is the biggest value, the model will predict the class of the text input as C4.

Next, the computer program may calculate the entropy of the predictive distribution, [symbol] , as follows:

$${ℋ}_{x} = - {\sum }_{k ∈ C} {p}_{m} ( y = k \vert x ) log {p}_{m} ( y = k \vert x )$$

where C is a set of target classes, and pₘ is a model generated predictive distribution. The target classes are pre-defined in the reference data.

In one embodiment, the computer program may optionally aggregate the predictive distributions generated by the classifiers, and may then calculate the entropy. For example, the aggregated predictive distributions may be calculated as follows:

$${p}_{E} = ( y = k \vert x ) = \frac{1}{\vert ℳ \vert} {\sum }_{m ∈ ℳ} {p}_{m} ( y = k \vert x )$$

where p_{E} is the aggregated predictive distribution, and [symbol] is a set of distinctive pre-trained classifiers from step 215. m refers to one of the individual classifiers in the set of [symbol] classifiers.

Instances where the entropy exceeds the threshold, which may be set by the user, may be classified as drifted.

In step 240, the covariate drifted instances from step 230 and the concept drifted instances from step 235, may be combined to identify final drifted instances.

In step 245, the user may update the annotations. For example, the computer program may receive the combined drifted instances and may generate sentence vectors of the drifted instances. The computer program may then select a number of samples, n, and may perform K-means clustering where K is set to n. n is a hyperparameter determined by users. For example, if a user wants to extract 500 clusters of representative examples, the user may set n to 500.

Next, the computer program may extract n samples that are the closest to the centroid of each cluster. For example, for each cluster, a sample that is closest to the cluster's centroid may be selected, resulting in n samples in total. For each cluster, the computer program may calculate the importance scores based on the distance to centroid and generate the ranking of each instance. The importance score represents the level of drift or the corresponding representative example. A higher importance score signifies a greater drift of the sample from the reference data. The importance score may be used to prioritize annotation by focusing first on the instances with the most drift.

For example, the computer program may calculate the Sum of Squared Errors (SSE), which measures the total squared distance between each data point and the centroid of its assigned cluster. The SSE indicates the compactness of the clusters and lower SSE implies the cluster is more compact and densely distributed. For each cluster, Sₙ may be calculated as follows:

$${S}_{n} = \frac{{N}_{n}}{{SSE}_{n}}$$

where Nₙ is the number of instances belong to the n-th cluster. Intuitively, a cluster becomes more important when it has more instances and is more compact, i.e., a low SSE. Therefore, a higher Sₙ denotes a greater drift of the representative instance of n-th cluster.

Next, a human may review and annotate the drifted instances. Humans may prioritize the annotation process by focusing on instances with higher importance score. This may be of benefit when there is a limited amount of human availability.

For example, a human may re-label the drifted instances, as they may fall in classes beyond the pre-defined classes. The re-labeled instances may then be added to the reference data.

In another embodiment, artificial intelligence models or similar may be used to re-label the drifted instances.

In one embodiment, the machine learning engine may be retrained with the relabeled instances.

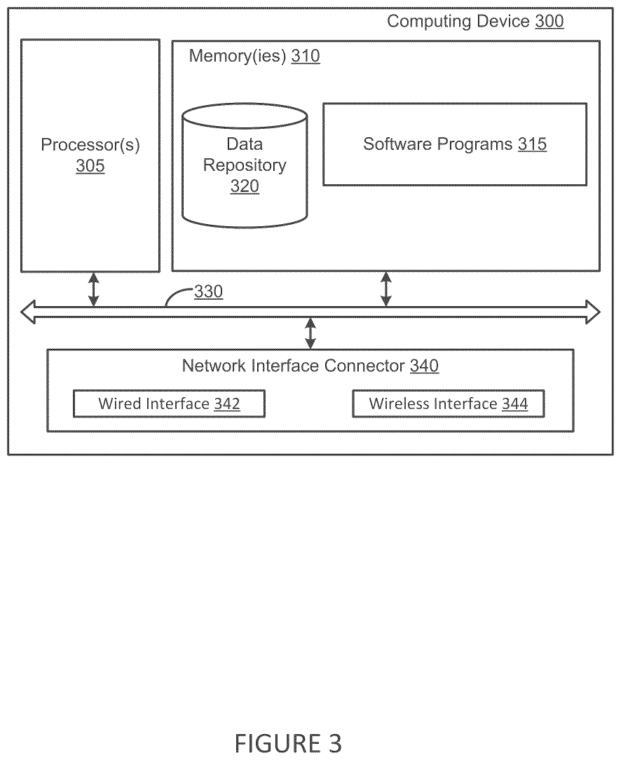

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program, reference data comprising input texts and corresponding labels;
training, by the computer program, a covariate drift detector comprising a syntactic drift detector and a semantic draft detector with the reference data;
training, by the computer program, a concept drift detector comprising a plurality of classifiers with the reference data;
receiving, by the computer program, production data comprising a plurality of instances;
determining, by the computer program, that the production data has drifted;
calculating, by the computer program, similarity scores between each instance of the production data and the reference data;
detecting, by the computer program, concept drift by generating a predictive distribution using the plurality of classifiers and calculating an entropy of the predictive distribution;
identifying, by the computer program, final drifted instances from the covariate drifted instances and the concept drifted instances; and
receiving, by the computer program, updated labels for the final drifted instances.

2. The method of claim 1, wherein the syntactic drift detector is trained by extracting content words from the reference data and calculating their frequencies.

3. The method of claim 1, wherein the semantic drift detector is trained by generating sentence vectors of the input texts in the reference data.

4. The method of claim 3, wherein the semantic drift detector comprises a variational autoencoder, and the variational autoencoder is trained with the generated sentence vectors.

5. The method of claim 1, wherein the syntactic covariate drift detector determines a likelihood of drift based on a frequency of content words.

6. The method of claim 4, further comprising:
setting, by the computer program, a configuration for the covariate drift detector using a content word frequency and an output of the variational autoencoder.

7. The method of claim 1, wherein the instances comprise a sentence, a paragraph, or an entire document.

8. The method of claim 1, further comprising:
calculating, by the computer program, a semantic covariate drift contribution score for each content word in the instances that are likely to have drifted; and
calculating, by the computer program, a syntactic covariate drift contribution score for each content word in instances of the production data that are likely to have drifted using the syntactic drift detector and the semantic draft detector.

9. A system, comprising:
a user electronic device executing a user computer program; and
an electronic device executing a computer program;
wherein:
the computer program receives, from a database, reference data comprising input texts and corresponding labels;
the computer program trains a covariate drift detector comprising a syntactic drift detector and a semantic draft detector with the reference data;
the computer program trains a concept drift detector comprising a plurality of classifiers with the reference data;
the computer program receives production data comprising a plurality of instances;
the computer program determines that the production data has drifted;
the computer program calculates similarity scores between each instance of the production data and the reference data;
the computer program detects concept drift by generating a predictive distribution using the plurality of classifiers and calculating an entropy of the predictive distribution;
the computer program identifies final drifted instances from the covariate drifted instances and the concept drifted instances; and
the computer program receives, from the user computer program,
updated labels for the final drifted instances.

10. The system of claim 9, wherein the syntactic drift detector is trained by extracting content words from the reference data and calculating their frequencies, and the semantic drift detector is trained by generating sentence vectors of the input texts in the reference data.

11. The system of claim 10, wherein the semantic drift detector comprises a variational autoencoder, and the variational autoencoder is trained with the generated sentence vectors.

12. The system of claim 9, wherein the syntactic covariate drift detector determines a likelihood of drift based on a frequency of content words.

13. The system of claim 11, wherein the computer program sets a configuration for the covariate drift detector using a content word frequency and an output of the variational autoencoder.

14. The system of claim 9, wherein the instances comprise a sentence, a paragraph, or an entire document.

15. The system of claim 9, wherein the computer program calculates a semantic covariate drift contribution score for each content word in the instances that are likely to have drifted, and a syntactic covariate drift contribution score for each content word in instances of the production data that are likely to have drifted using the syntactic drift detector and the semantic draft detector.

16. A non-transitory computer readable storage medium, including instructions stored thereon, which when read and executed by one or more computer processors, cause the one or more computer processors to perform steps comprising:
receiving reference data comprising input texts and corresponding labels;
training a covariate drift detector comprising a syntactic drift detector and a semantic draft detector with the reference data;
training a concept drift detector comprising a plurality of classifiers with the reference data;
receiving production data comprising a plurality of instances;
determining that the production data has drifted;
calculating similarity scores between each instance of the production data and the reference data;
detecting concept drift by generating a predictive distribution using the plurality of classifiers and calculating an entropy of the predictive distribution;
identifying final drifted instances from the covariate drifted instances and the concept drifted instances; and
receiving updated labels for the final drifted instances.

17. The non-transitory computer readable storage medium of claim 16,
wherein the syntactic drift detector is trained by extracting content words from the reference data and calculating their frequencies, and the semantic drift detector is trained by generating sentence vectors of the input texts in the reference data.

18. The non-transitory computer readable storage medium of claim 17,
wherein the semantic drift detector comprises a variational autoencoder, and the variational autoencoder is trained with the generated sentence vectors.

19. The non-transitory computer readable storage medium of claim 18, further including instructions stored thereon, which when read and executed by the one or more computer processors, cause the one or more computer processors to perform steps comprising:
setting a configuration for the covariate drift detector using a content word frequency and an output of the variational autoencoder.

20. The non-transitory computer readable storage medium of claim 16, further including instructions stored thereon, which when read and executed by the one or more computer processors, cause the one or more computer processors to perform steps comprising:
calculating a semantic covariate drift contribution score for each content word in the instances that are likely to have drifted; and
calculating a syntactic covariate drift contribution score for each content word in instances of the production data that are likely to have drifted using the syntactic drift detector and the semantic draft detector.
